(19) United States
(12) Patent Application Publication
(10) Pub. No.: US 2019/0059355 A1
(43) Pub. Date: Feb. 28, 2019

(54) DIGITAL RODENT COLLECTION TRAP

(71) Applicant: Devin Glenn Samuelson, Greenacres, WA (US)

(72) Inventor: Devin Glenn Samuelson, Greenacres, WA (US)

(21) Appl. No.: 15/685,401

(22) Filed: Aug. 24, 2017

(51) Int. Cl. A01M 23/10; A01M 31/00; A01M 23/18; H04Q 9/02

(52) U.S. Cl. CPC A01M 23/10; A01M 31/002; H04L 67/12; H04Q 9/02; A01M 23/18

(57) ABSTRACT

A rodent trap with a containment chamber which allow the capture, counting, containment and reporting of captured rodents such as rats or mice. The electromechanical trap has at least three main components, a microcontroller with memory, a sensor or switch, a stepping motor, an LCD display, and a cellular radio with one or more antenas. As the rodent influences a sensor by way of movement or pressure which causes a change in continuity of the circuit, a microcontroller is awakened from a sleep mode and actuates the rotation of a stepper motor, revolving a trap door to move the rodent to the containment location, count the capture, and report the count digitally.

### FIELD OF THE INVENTION

The present invention relates to rat traps and, more particularly, to multi-catch units which have the capacity to catch and store multiple rodents.

### BACKGROUND OF THE INVENTION

Rodents have plagued humans with disease infestation, disease transfer, and have been known to cause damage to structures and dwellings. Rats in particular have been growing in population faster than they are able to be eradicated in some metropolitan cities. Rats can carry disease-causing viruses such as sapoviruses, cardioviruses, kobuviruses, parechoviruses, rotaviruses, hepaciviruses, and Seoul virus. Rats carry fleas that are vectors of diseases such as bubonic plague, typhus, and spotted fever. In addition, some people have an allergic reaction to the presence of rodent feces, hair, or urine.

One such example of rat problems in metropolitan cities is exemplified in New York City, which has had a longstanding rat population problem. In 1860, The New York Times reported that a newborn infant had died prior to rats eating part of its face and one foot. The NYC Health Department undertook an anti-rat campaign in 1921 that involved rat-proofing as well as trapping and killing rats, (Quarterly Bulletin (New York (N.Y.). Dept. of Health). 1921-22)

Rats in New York have been known to overrun restaurants after hours and crawl up sewer pipes, (Barry Bearak (Jul. 14, 1994). “New York Losing the Rat Race: East Side, West Side, vermin are all around the town. But budget cuts and a trash incinerator ban have made this an especially miserable summer for weary residents and wary exterminators.” Los Angeles Times. Retrieved Jan. 9, 2016), as well as enter apartments through toilets, (“See How Easily a Rat Can Wriggle Up Your Toilet”, National Geographic. Retrieved Aug. 23, 2015). They have attacked homeless people, eaten cadavers in the city morgue, and bitten infants and young children to get food off their faces. (Wilsey, Sean (Mar. 17, 2005), “Some of them can read” London Review of Books. 27 (6). pp. 9-10. Retrieved Apr. 5, 2010).

In 2003, a fire station in Queens was condemned and demolished after rats had taken over the building, (Cilgann, Corey (Aug. 7, 2003). “A Detested Emblem of Decay Is Scurrying Back. Ah, Rats!”, The New York Times. Retrieved Apr. 6, 2010). In 2007, a morning news program featured a live report of a pack of rats overrunning a pair of fast food restaurants in Greenwich Village. In one of the restaurants, a KFC, numerous rats so severely infested the restaurant that they were visible in groups from the street, through the windows (Chan, Sewell (Dec. 5, 2006). “In Epic Battle, the Rat Patrol Adjusts Its Aim and Digs In”, The New York Times. New York.).

According to New York City Health Department statistics, there were 86 rat bites reported in 2010. Many bites go unreported (Alison Bowen (Dec. 26, 2014). “100 New Yorkers bitten by rats each year”. Metro.). In 2011, a video of a rat climbing on a sleeping man's face on the subway went viral (Josh Sanburn (Jan. 14, 2011). “Shocking NYC Subway Rat Video: Some Say It's Staged, But New Yorkers Know Better”. Time). Rats are so common that ex-Manhattan Borough President Scott Stringer quipped in 2013, “The rats don't scurry. They walk right up to you and say, ‘How are you, Mr. Borough President?’” (Rebecca Hiscott. “City Fights Back Against Upper West Side Rat Infestation”. Observer)

In 2014, New York City Councilman Mark D. Levine said at a public hearing that “We've had rats who are going into cars and eating out electrical cables. We have rats that are entering homes. (Tina Susman (May 30, 2014). “New York City declares war on rats”. Los Angeles Times.) He described the problem as “epidemic” on some streets in Manhattan. (Tina Susman (May 30, 2014). “New York City declares war on rats”. Los Angeles Times.). That year, YouTube videos of rats on subway tracks and in a subway car in New York City went viral, as did videos of rats in a Dunkin' Donuts in Manhattan. In June 2014, residents at adjacent Upper West Side buildings started a rent strike, demanding an end to the rat problem. Also in 2014, Allerton Coops in Bronx Park East received three Notices of Violation from the Health Department and was fined for their inadequate response to a severe rat infestation. (2015, “Pizza Rat: Our newest obsession”. CNN. Retrieved Sep. 23, 2015).

The video was trending worldwide on Twitter and Facebook within 15 hours of the YouTube upload, and garnered 5 million views within two days. (“The three stages of going viral in 2015, according to the Pizza Rat meme”. The Washington Post. Sep. 22, 2015. Retrieved Sep. 23, 2015).

In early 2016, another video of a rat climbing on a sleeping subway rider was uploaded to social media. The uploader was criticized for his choice to film the incident and post it online rather than intervene. (Rat filmed climbing on sleeping commuter on New York subway”. Daily Telegraph. Mar. 30, 2016. Retrieved Sep. 12, 2016)

With all of these known issues of rat problems, many have invented very clever devices to trap, kill, and contain the rodents.

Some other solutions that have been presented by others in the past include means whereby an individual rodent was captured or killed. However, with the quantities of rats or rodents needing to be controlled, these single catch solutions simply don't provide adequate coverage of infested areas which would require too numerous a count of traps to be cost effective. Multiple-catch traps have been previously invented, whereby a container is attached to the primary trap, enabling the containment of rats or rodents in a solution such as vinegar, to subdue or kill the rodent Means of drowning, electrocution, shock, and lethal trauma have all been used in prior art forms to rid society of an overabundance of these rodents. However, the problem with each of these solutions is that it is required that a human physically open these traps to gain knowledge about the count of rodents collected, and manually reset springs or mechanisms to re-initialize the count of the number of rodents collected in an area where the trap was placed.

This is not only cumbersome, but can be costly for a multiplicity of traps which are placed around a city to be monitored in such a manor.

### SUMMARY OF THE INVENTION

In accordance with the present invention, there is provided a rodent trap with a containment chamber which allow the capture, counting, containment and reporting of captured rodents such as rats or mice. The electromechanical trap has at least three main components; a microcontroller with memory, a sensor or switch, a stepping motor, an LCD display, and a cellular radio with one or more antennas. As the rodent influences a sensor by way of movement or pressure which causes a change in continuity of the circuit, a microcontroller is awakened from a sleep mode and actuates the rotation of a stepper motor, revolving a trap door to move the rodent to the containment location, count the capture, and report the count digitally.

It would be advantageous to provide a digitally activated trap door using a stepper motor, governed by a microcontroller, which eliminates the need for manually wound kinetic energy coils or springs to actuate the trap door or paddlewheel.

It would also be advantageous to provide a digital signal to an IC counter and RAM or Flash memory for future retrieval of the count associated with the serial number of the trap.

It would further be advantageous to provide an output monitor for reporting the count data, and other optional data such as battery life to an LCD screen, and to a transmitting radio such as a cellar radio to enable transmittal of the information to a cellular network for retrieval and notification, eliminating the need for unwarranted visits to the Digital Rodent Collection Trap.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front perspective view of a top trap and bottom containment canister assembly;

FIG. 2 is a left elevation view of a trap and containment assembly;

FIG. 3 is a left sectional view of a digital rodent trap and counter display;

FIG. 4 is a rear elevation view of a rat trap with climbing latter;

FIG. 5 is a front sectional view of a digital control system for a rat trap;

FIG. 6 is a front detail view of a microcontroller and communications system; and

FIG. 7 is a detail view of an operational flow diagram with loca paths.

For purposes of clarity and brevity, like elements and components will bear the same designations and numbering throughout the Figures.

### DESCRIPTION OF THE PREFERRED EMBODIMENT

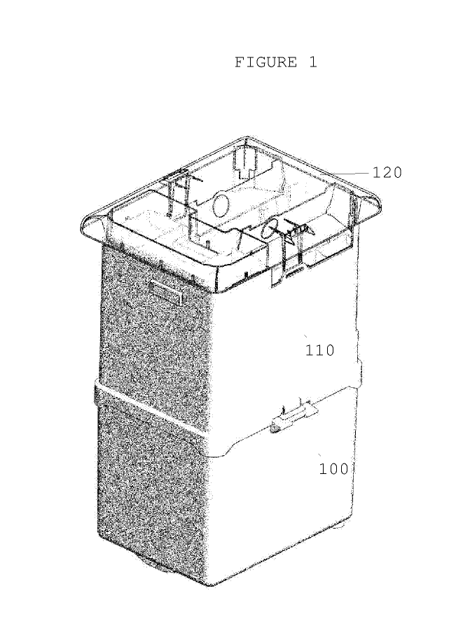

FIG. 1 is a front perspective view of a top trap and bottom containment canister assembly. These two system assembly articles comprise a rodent or rat trap with containment features. The containment canister base 100 acts as a base for the rat trap capture tower 110. The transparent lid and weather shield 120 provides a weather proofing roof, but allows for external visual inspection of the trap to assist in making sure rodent channels are cleared and operational.

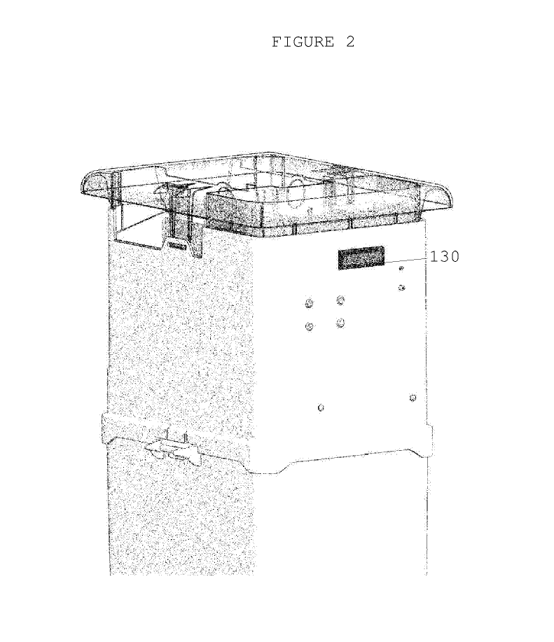

FIG. 2 is a left elevation view of a trap and containment assembly. The data display 130 provides real time counting data for the number of rodents captured for easy reference to users and trap maintenance persons. This digital data display 130 is localized, mounting on the inside of the rat trap capture tower 110, but protruding through the wall to provide easy external visibility.

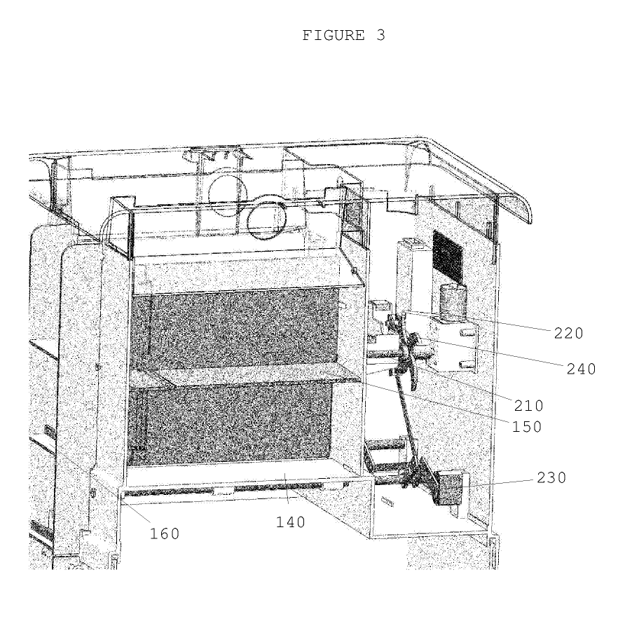

FIG. 3 is a left sectional view of a digital rodent trap and counter display. FIG. 3 illustrates the internal workings of the rat trap capture tower 110 and containment canister base 100. Starting with the containment canister base 100, the containment doors 140 are constructed of plastic, wood, or metal, and are fastened to a shafted hinge. The shaft is rotated by a weighted lever arm which are opened by a cam wheel gear 240. As the sensor or switch signals the microcontroller 170, the microcontroller 170 sends a signal to advance the stepper motor 220 90 degrees. This rotational motion forces the rodent or rat to fall through the opened containment doors 140 and into the containment canister base 100. The same microcontroller 170 also sends a signal that adds a count to its stored operational count, preparing the same data to be shared both locally through the data display 130, and globally through the radio device 180 as shown in the process flow diagram 250.

The rodent climbs the entry ladder 160 to gain access to the paddle-wheel trap floor. The rat is drawn or enticed up the entry ladder 160 and across the paddle-wheel trap floor to approach a feeder tray 200, where it smells food or other attractant. Upon moving across the trap floor of the paddle-wheel trap, the rodent initiates a sensor signal which is sent to the microcontroller 170, beginning the rapid actuation process shown in the process flow diagram 250 of capturing the rodent or rat. At the same time that the stepper motor 220 rotates the paddle-wheel trap, the containment doors 140 are opened while rotating about the containment door hinge 190, and acted upon by the trap door rotor shaft which is affixed to the containment door counter-weight 230 being acted upon by the cam wheel gear 240, fastened to the trap door rotary shaft. The containment door counter-weight 230 resets the trap by closing the containment doors 140. The containment doors 140 are only opened by the cam wheel gear 240 at time of actuation. The paddle-wheel trap door 150 resets automatically with the stepper motor 220.

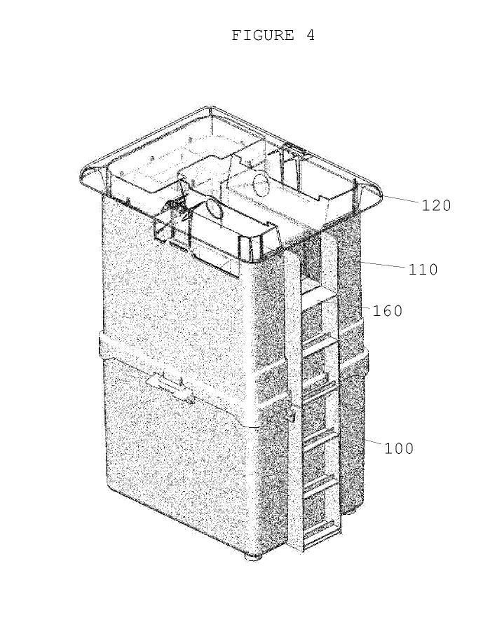

FIG. 4 is a rear elevation view of a rat trap with climbing latter. The rodent trap is comprised of a transparent lid and weather shield 120, with a rat trap capture tower 110 housing the electromechanical components to capture a rodent. The entry ladder 160 provides access to the rodent to enter the rat trap capture tower 110 The rat trap capture tower 110 rests upon its base the containment canister base 100.

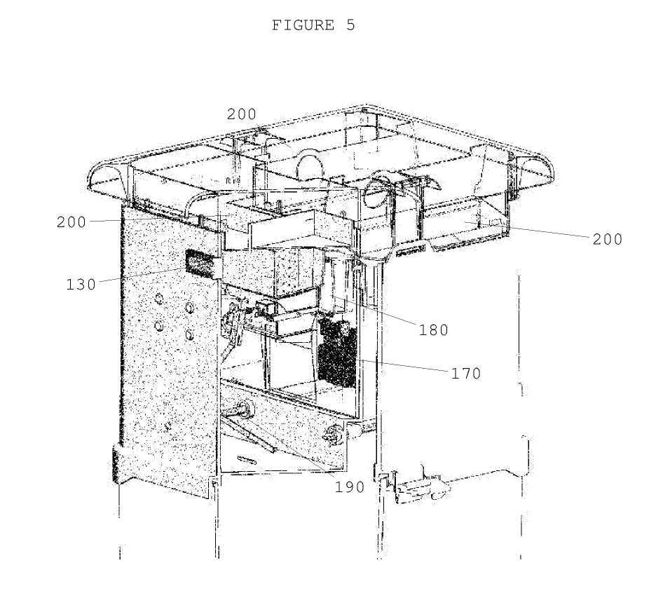

FIG. 5 is a front sectional view of a digital control system for a rat trap. From top to bottom, this figure illustrates the outside look at the functionality of the rat trap. With a transparent lid and weather shield 120, maintenance of the rat trap is able to be evaluated without having to make contact with the contaminants of the trap initially. Each feeder tray 200 can be viewed to evaluate the need for restocking. The digital display can be viewed to determine if the capacity of the containment canister base 100 is full or at capacity. Battery life is also able to be determined from the data display 130 screen. The radio device 180 is optionally programmed to send the data in a file format such as .csv or other useable format to a data center, the cloud, or cellar phone device for notification purposes as provided by the microcontroller 170. Containment door hinges rotate causing the containment doors 140 to open as a result of the mechanical actuation caused by the cam wheel gear 240 acted upon by the containment door counter-weight 230.

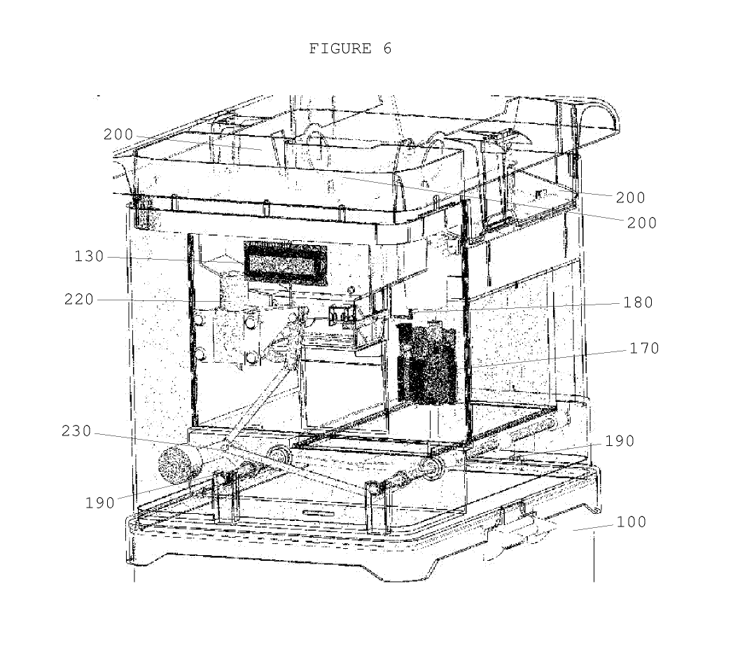

FIG. 6 is a front detail view of a microcontroller 170 and communications system. Although the transparent lid and weather shield 120 provides good visibility to each feeder tray 200, it does not provide visibility to the internal workings of the device such as its microcontroller 170. The transparent lid and weather shield 120 must be removed to access the moving hardware. The data display 130 screen is visible from outside of the rat trap capture tower 110, but is mounted from within. The microcontroller 170 communicates internally to the stepper motor 220 to actuate the cycle of rotation of the paddle-wheel trap door 150. This begins the chain reaction of mechanical and electrical activity, whereby the mechanical rotation about the containment door hinge 190 of the trap door rotary shaft rotates the cam wheel gear 240, lifting the containment door counter-weight 230, and rotates the containment door hinge 190, while the microcontroller 170 registers a count and sends an update to the digital data display 130 and radio device 180. The rodent is dropped, captured and contained within the containment canister base 100.

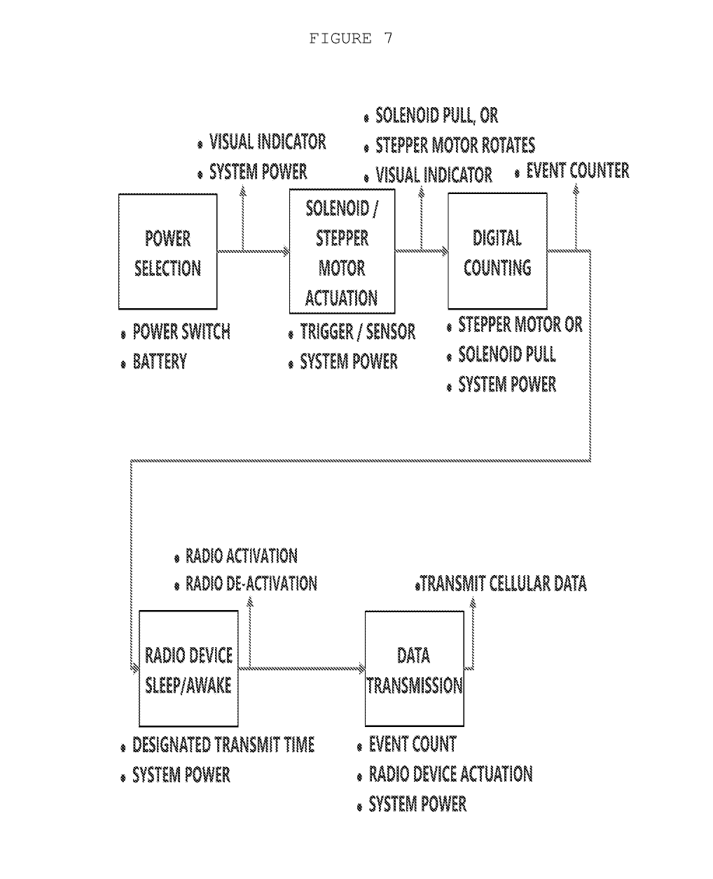

FIG. 7 is a detail view of an operational flow diagram with local paths. Contained within the process flow diagram 250 are each of the steps and their basic logic with inputs and outputs. The decision tree below each step of the process flow diagram 250 illustrates how the electromechanical and digital systems interact.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A digital rodent collection trap for catching and counting rodents, such as rats, while recording and reporting the quantity captured, comprising:
means for housing the trap door mechanisms, microcontroller, electronics, mechanics, sensors, motor, radio, and display and containment doors;
means for reporting data onboard, such as counts and system power status, securely fastened to said means for housing the trap door mechanisms, microcontroller, electronics, mechanics, sensors, motor, radio, and display and containment doors;
means for providing the platform which the rodent stands on until the sensor or switch is triggered, then the floor becomes rotating trap door;
means for controlling all sensor inputs and outputs, controlling power conservation of batteries, controlling motor rotations and timing, controlling data retrieval and storage, and having reporting functionality, sufficiently connected to said means for housing the trap door mechanisms, microcontroller, electronics, mechanics, sensors, motor, radio, and display and containment doors;
means for receiving information from the microprocessor then transmitting it to a cellular network, electrically connected to said means for controlling all sensor inputs and outputs, controlling power conservation of batteries, controlling motor rotations and timing, controlling data retrieval and storage, and having reporting functionality, and rigidly connected to said means for housing the trap door mechanisms, microcontroller, electronics, mechanics, sensors, motor, radio, and display and containment doors;
means for rotating the paddle-wheel trap door 90 degrees, rigidly connected to said means for housing the trap door mechanisms, microcontroller, electronics, mechanics, sensors, motor, radio, and display and containment doors;
means for lifting the rocker arm to open the containment doors; and
means for illustrating the process flow and logic for operational purposes of the digital trap, functionally embedded to said means for controlling all sensor inputs and outputs, controlling power conservation of batteries, controlling motor rotations and timing, controlling data retrieval and storage, and having reporting functionality.

2. The digital rodent collection trap in accordance with claim 1, wherein said means for housing the trap door mechanisms, microcontroller, electronics, mechanics, sensors, motor, radio, and display and containment doors comprises a stackable, plastic rat trap capture tower.

3. The digital rodent collection trap in accordance with claim 1, wherein said means for reporting data onboard, such as counts and system power status comprises a liquid crystal display data display.

4. The digital rodent collection trap in accordance with claim 1, wherein said means for providing the platform which the rodent stands on until the sensor or switch is triggered, then the floor becomes rotating trap door comprises a plastic, revolving door paddle-wheel trap door.

5. The digital rodent collection trap in accordance with claim 1, wherein said means for controlling all sensor inputs and outputs, controlling power conservation of batteries, controlling motor rotations and timing, controlling data retrieval and storage, and having reporting functionality comprises a digital, electronic microcontroller.

6. The digital rodent collection trap in accordance with claim 1, wherein said means for receiving information from the microprocessor then transmitting it to a cellular network comprises a cellular radio device.

7. The digital rodent collection trap in accordance with claim 1, wherein said means for rotating the paddle-wheel trap door 90 degrees comprises an incremental stepper motor.

8. The digital rodent collection trap in accordance with claim 1, wherein said means for lifting the rocker arm to open the containment doors comprises a plastic, metal, or wood cam wheel gear.

9. The digital rodent collection trap in accordance with claim 1, wherein said means for illustrating the process flow and logic for operational purposes of the digital trap comprises a flow chart, inputs and outputs process flow diagram.

10. A digital rodent collection trap for catching and counting rodents, such as rats, while recording and reporting the quantity captured, comprising:
a stackable, plastic rat trap capture tower, for housing the trap door mechanisms, microcontroller, electronics, mechanics, sensors, motor, radio, and display and containment doors;
a liquid crystal display data display, for reporting data onboard, such as counts and system power status, securely fastened to said rat trap capture tower;
a plastic, revolving door paddle-wheel trap door, for providing the platform which the rodent stands on until the sensor or switch is triggered, then the floor becomes rotating trap door;
a digital, electronic microcontroller, for controlling all sensor inputs and outputs, controlling power conservation of batteries, controlling motor rotations and timing, controlling data retrieval and storage, and having reporting functionality, sufficiently connected to said rat trap capture tower;
a cellular radio device, for receiving information from the microprocessor then transmitting it to a cellular network, electrically connected to said microcontroller, and rigidly connected to said rat trap capture tower;
an incremental stepper motor, for rotating the paddle-wheel trap door 90 degrees, rigidly connected to said rat trap capture tower;
a plastic, metal, or wood cam wheel gear, for lifting the rocker arm to open the containment doors; and
a flow chart, inputs and outputs process flow diagram, for illustrating the process flow and logic for operational purposes of the digital trap, functionally embedded to said microcontroller.

11. A digital rodent collection trap for catching and counting rodents, such as rats, while recording and reporting the quantity captured, comprising:
a stackable, plastic, rat trap capture tower, for housing the trap door mechanisms, microcontroller, electronics, mechanics, sensors, motor, radio, and display and containment doors;
a liquid crystal display, new attribute 2 data display, for reporting data onboard, such as counts and system power status, securely fastened to said rat trap capture tower;
a plastic, rotational, paired doors containment doors, for opening and closing to contain the rodent being caught;
a plastic, revolving door paddle-wheel trap door, for providing the platform which the rodent stands on until the sensor or switch is triggered, then the floor becomes rotating trap door;
a digital, electronic, microcontroller, for controlling all sensor inputs and outputs, controlling power conservation of batteries, controlling motor rotations and timing, controlling data retrieval and storage, and having reporting functionality, sufficiently connected to said rat trap capture tower;
a cellular, radio device, for receiving information from the microprocessor then transmitting it to a cellular network, electrically connected to said microcontroller, and rigidly connected to said rat trap capture tower;
an incremental stepper motor, for rotating the paddle-wheel trap door 90 degrees, rigidly connected to said rat trap capture tower;
a weighted, containment door counter-weight, for recoiling the lower containment doors into a closed position after synchronized rotational movement of the paddle-wheel trap door, rotationally linked to said rat trap capture tower;
a plastic, metal, or wood cam wheel gear, for lifting the rocker arm to open the containment doors, intermittently united to said containment door counter-weight; and
a flow chart, inputs and outputs process flow diagram, for illustrating the process flow and logic for operational purposes of the digital trap, functionally embedded to said microcontroller.
